(19) United States
(12) Patent Application Publication
(10) Pub. No.: US 2022/0112370 A1
(43) Pub. Date: Apr. 14, 2022

(54) POLYMERIC BLEND COMPOSITE AND PROCESS FOR PREPARING THE SAME

(71) Applicant: Gharda Chemicals Limited, Thane, Maharashtra (IN)

(72) Inventors: Aditi S. KAPADIA, Thane, Maharashtra (IN); Prakash D. TRIVEDI, Mumbai, Maharashtra (IN); Amol T. PATIL, Thane, Maharashtra (IN); Arup R. BHATTACHARYYA, Thane, Maharashtra (IN)

(21) Appl. No.: 17/424,269

(22) PCT Filed: Nov. 5, 2019
(86) PCT No.: PCT/IB2019/059477

§ 371 Date: Jul. 20, 2021

(30) Foreign Application Priority Data
Jan. 29, 2019 (IN) 201923003497

(51) Int. Cl. C08L 71/00; C01B 32/174

(52) U.S. Cl. CPC C08L 71/00; C08L 2205/16; C01B 2202/06; C01B 32/174

(57) ABSTRACT

A polymeric blend composite is provided which includes 60 wt % to 99 wt % Poly Ether Ketone Ketone (PEKK), 1 wt % to 6 wt % Multi walled carbon nanotubes (MWCNTs), and 0 wt % to 40 wt % Poly-(2,5-Benzimidazole) (ABPBI). A process for preparing the polymeric blend composite is also provided according to which 60 wt % to 99 wt % PEKK, 1 wt % to 6 wt % MWCNT and 0 wt % to 40 wt % ABPBI are mixed, followed by melt processing on a twin-screw extruder. The extrudates of the polymeric blend composite possess higher electrical conductivity and storage Modulus as compared to PEKK without MWCNTs and PEKK+ABPBI blends without MWCNTs.

This is an application for a patent of addition to the Indian Patent Application No. 201821001494 filed on 12 Jan. 2018, the entire contents of which are specifically incorporated herein by reference.

### FIELD OF THE DISCLOSURE

The present disclosure relates to a polymeric blend composite and a process for preparing the same.

### Definitions

As used in the present disclosure, the following term is generally intended to have the meaning as set forth below, except to the extent that the context in which it is used indicates otherwise.

To determine the graphitic nature of the carbonaceous products peaks at 1,350 and 1,590 cm⁻¹ were observed. The intensity ratio of these peaks, known as the D band (due to disordered carbon features) and G band (due to the ordered graphitic carbon features), respectively, represents the degree of graphitization of carbon in the reaction products.

I_{D}/I_{G} ratio: In Raman spectroscopy intensity ratio I_{D}/I_{G} determines the graphitic nature of the carbonaceous products, where I_{D} refers to the intensity of D-band (1350 cm⁻¹) observed due to disordered carbon features and I_{G} refers to the intensity of G-band (1580 cm⁻¹) observed due to the ordered graphitic carbon features. The ratio of intensity of D/G peaks is a measure of the defects present on carbon nanomaterials structure.

Storage Modulus: Storage modulus (E′) is a measure of stiffness of a material. It measures the stored energy.

Heat Deflection Temperature: Heat deflection temperature (HDT) refers to the temperature at which a polymer or plastic sample deforms under a specified load.

### BACKGROUND

The background information herein below relates to the present disclosure but is not necessarily prior art.

Poly ether ketone ketones (PEKKs) exhibit high glass transition temperature (T_{g}) and high melting temperature (Tₘ). Tₘ of PEKK strongly depends on the ratio between terephthalate (para linkages) over isophthalate (meta linkages) isomers in the main chain, which is noted as T/I ratio. Melting point of PEKK with 100% para linkages is close to 395° C. However, PEKK with highest Tₘ of 395° C. is known to be very difficult to process by standard plastics processing techniques and hence is not in commercial usage. It has been reported that Tₘ of PEKK decreases to about 360° C., 330° C. and 300° C. corresponding with PEKK with T/I ratios 80/20, 70/30 and 60/40 respectively. A tailor-made PEKK with lower Tₘ broadens the composite processing temperature range at lower temperatures to avoid degradation.

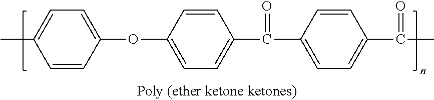

Poly(2,5-benzimidazole) (ABPBI), represented by the molecular formula (C₇H₄N₂)ₙ, is insoluble in water, organic solvents and does not have a melting temperature. ABPBI cannot be melt-processed up to 520° C., due to its high glass transition temperature (T_{g}) of 485° C. and the absence of Tₘ up to 600° C. Poly (2, 5-benzimidazole) tends to decompose before melting. ABPBI is thus extremely stable up to 650° C., but it is difficult to melt process. ABPBI is also highly resistant to most chemicals. In spite of possessing exceptional properties, it has not been fully explored as a polymer due to the difficulty in its processing. It is typically used as a solution cast membrane and has been evaluated as phosphoric acid impregnated proton exchange fuel cell membrane.

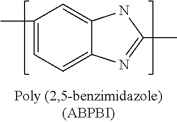

Typically, ABPBI is blended with binders, such as PEKK, to make it processable. The blend of PEKK/ABPBI thus formed has the properties of high performance material, and extremely high temperature stability. Further, the drawback of degradation of ABPBI is also eliminated.

However, the heat deflection temperature (HDT), and the DC electrical conductivity of PEKK/ABPBI blend is low. Further, uniform blending of the PEKK/ABPBI blend is difficult to achieve, which affects the stability of the obtained PEKK/ABPBI blend.

There is, therefore, felt a need for PEKK blends that mitigates the hereinabove mentioned drawbacks.

### Objects

Some of the objects of the present disclosure, which at least one embodiment herein satisfies, are as follows.

It is an object of the present disclosure to ameliorate one or more problems of prior art and to provide a useful alternative.

Another object of the present disclosure is to provide a polymeric blend composite of PEKK having a high electrical conductivity.

Still another object of the present disclosure is to provide a polymeric blend composite of PEKK with higher storage modulus reflecting higher rigidity at higher temperatures.

Yet another object of the present disclosure is to provide a stable polymeric blend composite of PEKK.

Still another object of the present disclosure is to provide a process for producing a polymeric blend composite of PEKK.

Other objects and advantages of the present disclosure will be more apparent from the following description, which is not intended to limit the scope of the present disclosure.

### SUMMARY

In a first aspect, the present disclosure relates to a polymeric blend composite. The polymeric blend composite comprises 60 wt % to 99 wt % poly(ether ketone ketone), 1 wt % to 6 wt % multi walled carbon nanotubes and 0 wt % to 40 wt % poly(2,5-benzimidazole), of the total weight of the polymeric blend composite. The poly(ether ketone ketone) has an inherent viscosity in the range of 0.60 to 1.8 dL/g. The poly(2,5-benzimidazole) has an inherent viscosity in the range of 0.90 to 4.00 dL/g. The polymeric blend composite has electrical conductivity in the range of 10⁻¹¹ to 10⁻⁴ S/cm, and storage modulus in the range of 2200 to 3400 MPa at a temperature of 50° C. and 250 to 500 MPa at a temperature in the range of 300° C.

In accordance with the present disclosure, the composite has heat deflection temperature (HDT) in the range of 175° C. to 191° C.

In a second aspect, the present disclosure provides a process for preparing the polymeric blend composite. The process comprises pre-treating multi walled carbon nanotubes to obtain pre-treated multi walled carbon nanotubes, followed by mixing 60 wt % to 99 wt % of poly(ether ketone ketone), 1 wt % to 6 wt % of pre-treated multi walled carbon nanotubes and 0 wt % to 40 wt % of poly (2,5-benzimidazole) to obtain a powder of dry blend. The powdered dry blend is extruded at a temperature in the range of 300° C. to 450° C. to obtain the polymeric blend composite in the form of extrudates and the extrudates are pelletized to obtain said polymeric blend composite in the form of granules, by using a molding technique selected from the group consisting of injection molding, extrusion molding and compression molding.

In accordance with the present disclosure, the multi walled carbon nanotubes are pre-treated by ultrasonicating a mixture of multi walled carbon nanotubes and water at a frequency in the range of 15 to 25 kilohertz for a time period in the range of 10 minutes to 60 minutes to obtain uniformly dispersed multi walled carbon nanotubes. The uniformly dispersed multi walled carbon nanotubes are dried, under reduced pressure in the range of 760 mmHg to 60 mmHg, at a temperature in the range of 80° C. to 120° C. for a time period in the range of 1 hour to 48 hours to obtain the pre-treated multi walled carbon nanotubes.

### BRIEF DESCRIPTION OF THE ACCOMPANYING DRAWING

The polymeric blend composite of the present disclosure will now be described with the help of the accompanying drawing, in which:

FIG. 1 illustrates a graphical representation of DC electrical conductivity versus various weight percentages of MWCNTs (wt %) used in PEKK/ABPBI polymeric blend composite.

FIG. 2 illustrates a graphical representation of DC electrical conductivity versus various weight percentages of MWCNTs (wt %) used in PEKK (100%); and

FIG. 3 represents a graph illustrating the storage modulus of the polymeric blend composite of PEKK (100%) and PEKK+ABPBI (80/20 wt/wt) having varying weight percentages of MWCNTs (wt %) at different temperatures (200° C., 250° C., and 300° C.) in accordance with the present disclosure.

### DETAILED DESCRIPTION

Embodiments, of the present disclosure, will now be described with reference to the accompanying drawing.

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, integers, steps, operations, elements, modules, units and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

As used herein, the term “and/or” includes any and all combinations of one or more of the associated listed elements.

The terms first, second, third, etc., should not be construed to limit the scope of the present disclosure as the aforementioned terms may be only used to distinguish one element, component, region, layer or section from another component, region, layer or section. Terms such as first, second, third etc., when used herein do not imply a specific sequence or order unless clearly suggested by the present disclosure.

Currently, the blends of Poly ether ketone ketones (PEKK) and/or Poly (2, 5-benzimidazole) (ABPBI) have properties related to high performance material. However, properties such as, electrical conductivity, heat deflection temperature (HDT), storage modulus, and the rigidity of known PEKK/ABPBI blends are not of the desired level, restricting their use in high end applications such as connectors, thermal interface materials, heat sinks, electronics packaging, self-regulating heaters, PTC resistors, and in transport industry.

The present disclosure envisages a polymeric blend composite comprising PEKK, MWCNTs and optionally ABPBI, having high electrical conductivity, stiffness, and higher stability.

In an aspect of the present disclosure, a polymeric blend composite comprises 60 wt % to 99 wt % poly(ether ketone ketone), 1 wt % to 6 wt % multi walled carbon nanotubes and 0 wt % to 40 wt % poly(2,5-benzimidazole), of the total weight of the polymeric blend composite. The poly(ether ketone ketone) has an inherent viscosity in the range of 0.60 to 1.8 dL/g. The poly(2,5-benzimidazole) has an inherent viscosity in the range of 0.90 to 4.00 dL/g. The polymeric blend composite has an electrical conductivity in the range of 10⁻¹¹ to 10⁻⁴ S/cm, storage modulus in the range of 2200 to 3400 MPa at a temperature of 50° C. and 250 to 500 MPa at a temperature in the range of 300° C.

Poly ether ketone ketones (PEKKs) exhibit high glass transition temperature (T_{g}) and high melting temperature (Tₘ). Tₘ of Poly ether ketone ketones strongly depends on the ratio between terephthalate (para linkages) over isophthalate (meta linkages) isomers in the main chain, which is noted as T/I ratio. Melting point of PEKK with 100% para linkages (close to 395° C.). However, PEKK with highest Tₘ of 395° C. is known to be very difficult to process by standard plastics processing techniques and hence is not in commercial usage. It has been reported that the Tₘ of PEKK decreases to about 360° C., 330° C. and 300° C. corresponding with PEKK with T/I ratios 80/20, 70/30 and 60/40 respectively. Thus, a tailor-made PEKK with lower Tₘ broadens the composite processing temperature range at lower temperatures to avoid degradation.

In the present disclosure, the inherent viscosity of the poly (ether ketone ketones) is in the range of 0.70 to 1.1 dL/g.

The weight average molecular weight (M_{w}) of the PEKK is in the range of 50,000 to 60,000.

In accordance with the embodiments of the present disclosure, the bulk density of said poly (2,5-benzimidazole) is in the range of 1.00 to 3.00 dL/g.

In accordance with the embodiments of the present disclosure, the multi walled carbon nanotubes have an I_{D}/I_{G} value in the range of 0.9 to 1.2.

In accordance with an embodiment of the present disclosure, the multi walled carbon nanotubes have an I_{D}/I_{G} value of 1.1.

In one embodiment, the polymeric blend composite comprises PEKK and MWCNTs.

In accordance with the embodiments of the present disclosure, the weight ratio of PEKK to MWCNTs in the polymeric blend composite is in the range of 94:6 to 99:1.

Multi-walled carbon nanotubes (MWCNTs) in their disentangled and individualized state have tensile strength up to 100 GPa; and exhibits high aspect ratio, resistance to high temperature (beyond 500° C.), high strength to weight ratio (due to their low density), chemical stability, and thermal conductivities greater than copper and diamond.

In one embodiment of the present disclosure the amount of MWCNTs is 5 wt %.

In another embodiment, of the present disclosure the amount of MWCNTs is 1 wt %.

Typically, the purity of the MWCNTs used in the polymeric blend composite of the present disclosure is greater than 90%, which corresponds to I_{D}/I_{G}=1.10 (I_{D} refers to the intensity of the disordered D-band and I_{G} refers to the intensity of the ordered G-band).

In one embodiment of the present disclosure, MWCNT used is Nanocyl NC 7000.

In another embodiment, the polymeric blend composite comprises PEKK, MWCNTs, and ABPBI.

In the present disclosure, the inherent viscosity of the ABPBI is in the range of 1.00 dL/g to 3.00 dL/g.

In accordance with the embodiments of the present disclosure, the weight ratio of the poly (ether ketone ketone) to the poly (2, 5-benzimidazole) is in the range of 60:40 to 100:0.

In accordance with an embodiment of the present disclosure, the weight ratio of said poly (ether ketone ketone) to said poly (2, 5-benzimidazole) is 80:20.

In an exemplary embodiment of the present disclosure, the polymeric composite of the present disclosure comprises 76 wt % PEKK and 19 wt % ABPBI and 5 wt % MWCNTs.

ABPBI is a solid, odorless, reddish brown colored thermosetting polymer having a bulk density in the range of 0.2 to 0.3 g/cm³. It is insoluble in water and an organic solvent even at high temperatures and does not have a melting temperature. ABPBI alone cannot be melt processed up to 520° C. due to its high glass transition temperature (T_{g}) of 485° C. and the absence of Tₘ up to 600° C.

In accordance with the present disclosure, the bulk density of ABPBI is in the range of 0.20 to 0.30 g/cm³.

The electrical conductivity of the polymeric blend composite of the present disclosure increases with increase in the MWCNT loading in the range of 1 to 5%.

The polymeric blend composite of the present disclosure is characterized by having an electrical conductivity in the range of 10⁻¹¹ to 10⁻⁴ S/cm.

The storage modulus of the polymeric blend composite of the present disclosure increases with increase in the MWCNT loading.

The storage modulus of the polymeric blend composite of the present disclosure having a known loading of the MWCNT, decreases with increase in temperature in the range of 50° C. to 300° C.

The Heat Deflection Temperature (HDT) of the polymeric blend composite of the present disclosure increases with increase in the MWCNT loading in the range of 1 to 5%.

The HDT of the polymeric blend composite of the present disclosure is in the range of 175 to 191° C.

The electrical conductivity of the blend composite in the absence of MWCNT (0 wt %) is 10⁻¹¹ S/cm which is not desirable for making the articles.

In an embodiment, the electrical conductivity of the blend composite comprising 3 wt % MWCNTs is 10⁻⁷ S/cm.

In another embodiment, the electrical conductivity of the blend composite comprising 4 wt % MWCNTs is 10⁻⁷ S/cm.

In yet another embodiment, the electrical conductivity of the blend composite comprising 5 wt % MWCNTs is 10⁻⁴ S/cm.

In another aspect of the present disclosure, there is provided a process for preparing a polymeric blend composite comprising 60 wt % to 99 wt % of a poly(ether ketone ketone), 1 wt % to 6 wt % of pre-treated multi walled carbon nanotubes and 0 wt % to 40 wt % of poly (2,5-benzimidazole). The process comprises pre-treating multi walled carbon nanotubes to obtain pre-treated multi walled carbon nanotubes. The pre-treated multi walled carbon nanotubes (1 wt % to 6 wt %), poly(ether ketone ketone) (60 wt % to 99 wt %), and poly (2,5-benzimidazole) (0 wt % to 40 wt %) are mixed to obtain a powder dry blend. The powder dry blend is extruded at a temperature in the range of 300° C. to 450° C. to obtain the polymeric blend composite in the form of extrudates. The extrudates are pelletized, using a molding technique selected from the group consisting of injection molding, extrusion molding and compression molding, to obtain the polymeric blend composite in the form of granules.

MWCNTs tend to agglomerate, making it difficult to control the dispersion of the MWCNTs in the polymer blend composite. It is well known that without dispersion, the blend properties are not significantly improved. Therefore, the MWCNTs used in the polymeric blend composite of the present disclosure are pre-treated by ultrasonication to overcome the problem of agglomeration. The MWCNTs, when dispersed in the polymeric blends, show high rigidity at higher temperatures when properly integrated into the polymeric blend to form a composite structure, as the degree of entanglement and the linearity of the MWCNTs also impact the performance of the polymeric blend composite.

In accordance with the present disclosure, the MWCNTs are pre-treated by initially dispersing it in de-ionized water by ultrasonication. Ultrasonicator generates sound waves of high frequencies in the range of 15 to 25 kilohertz (kHz). The sound waves generated, subsequently create ‘bubbles’, which agitate the MWCNTs present in the ultrasonication chamber. The MWCNTs are typically ultrasonicated for a time period in the range of 10 to 60 minutes at ambient temperatures. Subjecting the MWCNTs to ultrasonication reduces the cluster formation (agglomeration) and provides uniformly dispersed MWCNTs. The so obtained uniformly dispersed MWCNTs is dried at a temperature in the range of 80° C. to 120° C. for a time period in the range of 1 hour to 24 hours under vacuum 500 mm of Hg, to obtain the pre-treated MWCNTs. The pre-treated MWCNTs are used in the preparation of the polymeric blend composite.

In an embodiment, a pre-determined amount of powdered PEKK and ABPBI are dry mixed with the pre-treated MWCNTs, to obtain a mixture. The mixing can be carried out using any mixer, such as a high speed mixer.

The blend mixture is further extruded to obtain strands of the polymeric blend composites of the present disclosure. The extrusion is carried out in a twin screw extruder which typically provides a high shear rate.

Extrusion of PEKK/ABPBI+MWCNTs composites using a twin screw extruder tends to break or not allow formation of agglomeration of nanomaterials in the composites due to applied high shear.

The speed of extruder screws can be in the range of 350 rpm to 450 rpm. The extrusion can be carried out at a temperature in the range of 370° C. to 420° C. The process of extrusion comprises feed zone, compression zone, metering zone, and die. Further, temperature of feed zone can be typically in the range of 320° C. to 340° C., compression zone temperature can be in the range of 340° C. to 375° C., and metering zone temperature can be in the range of 375° C. to 400° C., and die temperature can be in the range of 390° C. to 420° C. The length to diameter (LID) ratio of the extruder can be in the range of 25 to 35. In one embodiment, the L/D ratio of the extruder is 30.

The polymeric blend composite in the form of extrudates is further processed by pelletizing to produce granules. In an embodiment, the extrudates of the polymeric blend composite are cooled in air and pelletized to obtain granules, and then dried in an oven at a temperature in the range of 150° C. to 200° C., generally above the glass transition temperature of PEKK (T_{g}˜152° C.) for a time period of 1 to 5 hours to obtain polymeric blend composite in the form of dried pellets.

Pelletizing of extrudates of polymeric blend composites is carried out using a molding technique selected from the group consisting of injection molding, extrusion molding and compression molding.

Injection Molding can be carried out in an injection molding machine at a temperature in the range of 350° C. to 450° C.

The polymeric blend composites containing MWCNTs obtained by the process of the present disclosure exhibit high electrical conductivity and improved storage modulus as compared to the polymeric blends comprising PEKK and ABPBI.

The polymeric blend composite of the present disclosure can find applications as connectors, thermal interface materials, heat sinks, electronics packaging, self-regulating heaters, PTC resistors, in transport industry especially in aerospace structures, which require a reduction in weight and fuel consumption. These composites can also be used in aeronautical structural components like wing panels, horizontal and vertical stabilizers and some elements of the fuselage. The applications of the polymeric blend composite, thus formed is not restricted its use only to the aforestated applications, but can find in applications in various other sectors where high performance and high temperature resistant materials are required.

The foregoing description of the embodiments has been provided for purposes of illustration and not intended to limit the scope of the present disclosure. Individual components of a particular embodiment are generally not limited to that particular embodiment, but, are interchangeable. Such variations are not to be regarded as a departure from the present disclosure, and all such modifications are considered to be within the scope of the present disclosure.

The present disclosure is further described in light of the following experiments which are set forth for illustration purpose only and not to be construed for limiting the scope of the disclosure. The following experiments can be scaled up to industrial/commercial scale and the results obtained can be extrapolated to industrial scale.

### EXPERIMENTAL DETAILS

Experiment 1: Preparation of PEKK/ABPBI Blends (PEKK/ABPBI 80/20 wt/wt Ratio) and with Multi-Walled Carbon Nanotubes in Accordance with the Present Disclosure

Step-I: Pre-Treatment of MWCNTs

The MWCNTs used in the experiments were Nanocyl NC 7000. MWCNTs Nanocyl NC 7000 was procured from Nanocyl Inc. Sambreville, Belgium.

185 grams of MWCNTs were mixed with 3900 ml of de-ionized water and ultrasonicated (Ultrasonicator ANM Alliance) at a frequency of 20 kilohertz (kHz) for a time period of 20 minutes. After ultrasonication, uniformly dispersed MWCNTs were obtained. The so obtained uniformly dispersed MWCNTs were dried at 80° C. 182 grams pre-treated MWCNTs were obtained.

Step-II: General Process of Preparation of the PEKK+ABPBI+MWCNTs Polymeric Blend Composite (80/20) (wt/wt)

532 grams of PEKK powder (inherent viscosity 0.7 dL/g), 133 grams of ABPBI (inherent viscosity 1.3 dL/g) powder (PEKK:ABPBI ratio 80:20), and 35 grams (5 wt %) (Sample code: 95(PK80A20)T5 as provided in Table 1) of pre-treated MWCNTs as obtained in Step-I were mixed in a high speed mixer for 10 minutes. The resultant mixture was extruded using a twin screw extruder (W&P Coperion ZSK 26, LID ratio 30) at 400 rpm with barrel zones temperatures of 320-420° C., and die temperature of 380 to 420° C. to obtain the polymeric blend composite in the form of strands, which were air-cooled and further pelletized (using Glaves Corporation pelletizer), followed by drying at 180° C. for 2-3 hours.

The pellets were injection molded (using Arburg All Rounder 320C injection molding machine) at 1400 bar injection pressure and 1200 bar holding pressure and dosage volume of 25 cc and injection flow of 35 cc/s to obtain molded samples.

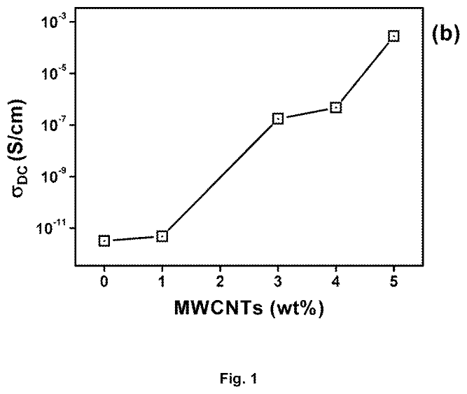

DMTA was measured using TA Instruments DMA Q800 in dual cantilever mode as a function of temperature at 1 Hz frequency. DMA sample dimensions were 63.5×12.7×3.24 mm. HDT was measured using Instron-Ceast, Italy HV-500 HDT/Vicat system and electrical conductivity was measured on sample dimensions 12.7×12.7×3.24 mm and HDT was measured at 0.25 mm deflection in edgewise position. Electrical conductivity was measured using Broadband Dielectric Spectrometer, Novocontrol, Germany Model Concept 80 using sample dimensions of 12.7×12.7×3.24 mm, with specimens coated on both surfaces with conductive silver paste to minimize surface resistance. The electrical conductivity of this composite is 10⁻⁴ S/cm. The results are presented in Table 1 and FIG. 1.

Experiment 2

Similar procedure as given in step II of experiment 1 was followed, by mixing, extruding and injection molding 0 wt % MWCNTs to obtain injection molded specimens of the polymeric blend composite (sample code: 100(PK80A20)T0 as provided in Table 1) for DMA, electrical conductivity and HDT. The electrical conductivity of this composite is 10⁻¹¹ S/cm.

Experiment 3

Similar procedure as given in experiment 1 was followed by mixing, extruding and injection molding 1 wt % MWCNTs to obtain injection molded specimens of polymeric blend composite (Sample code: 99(PK80A20)T1 as provided in Table 1) for DMA, electrical conductivity and HDT, giving The electrical conductivity of this composite is 10⁻¹¹ S/cm.

Experiment 4

Similar procedure as given in experiment 1 was followed by mixing, extruding and injection molding 3 wt % MWCNTs to obtain injection molded specimens of polymeric blend composite (Sample code: 97(PK80A20)T3 as provided in Table 1)) for DMA, electrical conductivity and HDT. The electrical conductivity of this composite is 10⁻⁷ S/cm.

Experiment 5

Similar procedure as given in experiment 1 was followed by mixing, extruding and injection molding 4 wt % MWCNTs to obtain injection molded specimens of polymeric blend composite (Sample code: 96(PK80A20)T4 as provided in Table 1) for DMA, electrical conductivity and HDT. The electrical conductivity of this composite is 10⁻⁷ S/cm.

FIG. 1 illustrates DC electrical conductivity with respect to various weight percentages of MWCNTs (wt %) added to (PEKK+ABPBI (80:20)) composite.

Experiment 6

Similar procedure as given in experiment 1 was followed except by mixing, extruding and injection molding PEKK with 0 wt % MWCNTs to obtain injection molded specimens of polymeric blend composite. (Sample Code: PK100T0 as provided in Table 1) for DMA, electrical conductivity and HDT. The electrical conductivity of this composite is 10⁻¹¹ S/cm.

Experiment 7

Similar procedure as given in experiment 1 was followed except by mixing, extruding and injection molding PEKK with 1 wt % MWCNTs to obtain injection molded specimens of polymeric blend composite. (Sample Code: PK99T1 as provided in Table 1) for DMA, electrical conductivity and HDT. The electrical conductivity of this composite is 10⁻¹¹ S/cm.

Experiment 8

Similar procedure as given in experiment 1 was followed except by mixing, extruding and injection molding PEKK with 3 wt % MWCNTs to obtain injection molded specimens of polymeric blend composite. (Sample Code: PK97T3 as provided in Table 1) for DMA, electrical conductivity and HDT. The electrical conductivity of this composite is 10⁻⁸ S/cm.

Experiment 9

Similar procedure as given in experiment 1 was followed except by mixing, extruding and injection molding PEKK with 4 wt % MWCNTs to obtain injection molded specimens of polymeric blend composite. (Sample Code: PK96T4 as provided in Table 1) for DMA, electrical conductivity and HDT. The electrical conductivity of this composite is 10⁻⁷ S/cm.

Experiment 10

Similar procedure as given in experiment 1 was followed except by mixing, extruding and injection molding PEKK with 5 wt % MWCNTs to obtain injection molded specimens of polymeric blend composite. (Sample Code: PK95T5 as provided in Table 1) for DMA, electrical conductivity and HDT. The electrical conductivity of this composite is 10⁻⁵ S/cm.

Electrical conductivity values of PEKK and PEKK+ABPBI (80/20 wt/wt) blends reinforced with MWCNTs are listed in Table 1.

TABLE 1
Heat Deflection Temperature (HDT) and Electrical Conductivity Measurements
of composites of PEKK + ABPBI (80/20) (wt/wt) and PEKK containing MWCNTs

| | PEKK + ABPBI | Nanocyl | | AC Electrical | | |
|---|---|---|---|---|---|---|
| Example | (80/20) Polymer | NC 7000 | | Conductivity | Surface | Nature of the |
| No. | Blend (wt/wt) | MWCNTs wt % | HDT ° C. | at 10 Hz S/cm | Resistivity Ω | Composite |
| 1 | 95 wt % | 5 | 188 | 10⁻⁴ | 10⁴ | Conductive |
| 2 | 100 wt % | 0 | 172 | >10⁻¹¹ | 10¹⁰ | Anti-Static |
| 3 | 99 wt % | 1 | 175 | 10⁻¹¹ | 10¹⁰ | Anti-Static |
| 4 | 97 wt % | 3 | 180 | 10⁻⁷ | 10⁷ | Static |
| | | | | | | Dissipative |
| 5 | 96 wt % | 4 | 190 | 10⁻⁷ | 10⁵ | Conductive |
| | PEKK wt % | MWCNTs wt % | | | | |
| 6 | 100 wt % | 0 | 170 | >10⁻¹¹ | 10¹⁰ | Anti-Static |
| 7 | 99 wt % | 1 | 178 | 10⁻¹¹ | 10¹⁰ | Anti-Static |
| 8 | 97 wt % | 3 | 182 | 10⁻⁸ | 10⁸ | Static- |
| | | | | | | Dissipative |
| 9 | 96 wt % | 4 | 189 | 10⁻⁷ | 10⁷ | Static |
| | | | | | | Dissipative |
| 10 | 95 wt % | 5 | 185 | 10⁻⁵ | 10⁶ | Conductive |

Note:
Electrostatic discharge (ESD) Materials Categories: Base Polymers: Insulating: 10¹³ to 10¹⁶ Ω, Anti-static: 10¹⁰ to 10¹² Ω, Static Dissipative Composites 10⁷ to 10⁹ Ω, Conductive Composites 10³ to 10⁶ Ω, Shielding Composites 1 to 10² Ω, Carbon Powders & Fibers 10⁻³ to 10⁻¹ Ω, Metals 10⁻⁵ to 10⁻⁴ Ω.
Surface Resistivity = ρₛ = Rₛ (P/G) Ω per square cm,
R = Surface Resistance, P = Perimeter of electrodes, G = Gap distance between electrodes.

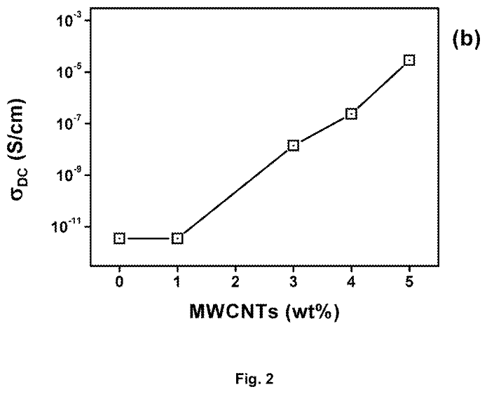

FIG. 2 illustrates DC electrical conductivity with respect to various weight percentages of MWCNTs (wt %) added to PEKK (100%).

The polymeric blend composite (PEKK+ABPBI (80:20))+1 wt % to 5 wt % MWCNTs of the present disclosure exhibits electrical conductivity in the range of 10⁻¹¹ to 10⁻⁴ S/cm as compared to (PEKK+ABPBI (80:20)) blend without MWCNTs which exhibits electrical conductivity in the range of 10⁻¹¹, as presented in Table 1.

From results presented in Table-1 it is clearly observed that PEKK+ABPBI (80:20 wt/wt) composite containing 5 wt % MWCNTs shows higher electrical conductivity than PEKK composite containing 5 wt % MWCNTs. Thus, addition of ABPBI to PEKK leads to formation of conductive network-like structures and the higher electrical conductivity of the blend is attributed to these conductive network-like structures.

The polymeric blend composites of the present disclosure, PEKK containing 0 to 5 wt % MWCNTs, and PEKK+ABPBI (80:20 WT/WT) containing 0 to 5 wt % MWCNTs were tested for storage modulus. Storage Modulus was obtained using TA System DMA equipment in the temperature range of 30° C. to 350° C. The method used for testing was ASTM D 7028 at Frequency was set at 1 Hertz (Hz). Amplitude was set at 50 μm. The results obtained are summarized in Table-2.

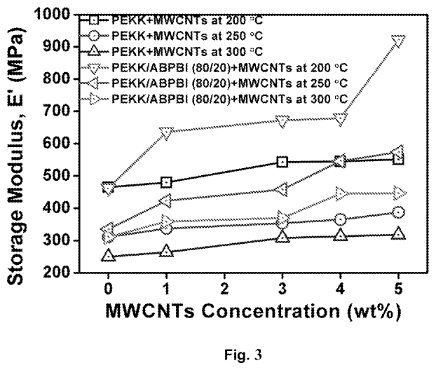

FIG. 3 represents a graph illustrating the storage modulus of the polymeric blend composite of PEKK and ABPBI (80/20 wt/wt) and PEKK (100%) versus varying weight percentages of MWCNTs at different temperatures (200° C., 250° C., and 300° C.) in accordance with the present disclosure.

TABLE 2
Storage Modulus of PEKK and (PEKK + ABPBI (80/20) (wt/wt)) blends
as a function of Temperature for 0-5 weight percentage of MWCNTs.

| | T_{g} by tan δ | Storage Modulus (E′) at different temperatures (MPa) | | | | | | |
|---|---|---|---|---|---|---|---|---|
| Expt. No. | ° C. | 50° C. | 140° C. | 150° C. | 180° C. | 200° C. | 250° C. | 300° C. |
| [PEKK + ABPBI (80/20) | | | | | | | | |
| (wt/wt) + MWCNTs] | | | | | | | | |
| 1 [95(PK80A20)T5] | 185 | 3292 | 3016 | 2995 | 1953 | 921 | 574 | 447 |
| 2 [100(PK80A20)T0] | 182 | 2282 | 2162 | 2125 | 1008 | 462 | 335 | 311 |
| 3 [99(PK80A20)T1] | 183 | 2425 | 2348 | 2315 | 1134 | 636 | 423 | 359 |
| 4 [97(PK80A20)T3] | 183 | 2701 | 2496 | 2452 | 1173 | 672 | 458 | 370 |
| 5 [96(PK80A20)T4] | 184 | 2721 | 2551 | 2503 | 1182 | 679 | 546 | 445 |
| PEKK + MWCNTs | | | | | | | | |
| 6 [PK100T0] | 181 | 2481 | 2306 | 2289 | 780 | 465 | 311 | 250 |
| 7 [PK99T1] | 182 | 2545 | 2361 | 2319 | 794 | 480 | 337 | 264 |
| 8 [PK97T3] | 183 | 2628 | 2433 | 2379 | 882 | 543 | 354 | 308 |
| 9 [PK96T4] | 183 | 2710 | 2462 | 2413 | 1007 | 545 | 365 | 313 |
| 10 [PK95T5] | 185 | 2887 | 2628 | 2570 | 1093 | 551 | 387 | 318 |

Conditions: Fixture: Dual-Cantilever, Frequency = 1 Hz, Amplitude = 50 μm, ASTM D 7028 Sample Dimensions: 63.5 mm × 12.7 mm × 3.24 mm (as per ASTM D 256)

From results presented in Table-2 it is clearly observed that the Storage Modulus of the PEKK+ABPBI+MWCNTs composites is higher than PEKK+MWCNTs composites at high temperatures in the range of 200° C. to 300° C. Thus, addition of ABPBI to PEKK leads to improved mechanical properties.

It is observed from the Table-2 that the high temperature storage modulus of PEK+ABPBI+MWCNTs blend composites is 25%-50% higher than high temperature storage modulus of PEKK+MWCNTs composites.

Technical Advancements

The present disclosure described herein above has several technical advantages including, but not limited to, the realization of polymeric blend composites having high electrical conductivity, and improved storage modulus.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the invention to achieve one or more of the desired objects or results. While certain embodiments of the inventions have been described, these embodiments have been presented by way of example only, and are not intended to limit the scope of the inventions. Variations or modifications to the formulation of this invention, within the scope of the invention, may occur to those skilled in the art upon reviewing the disclosure herein. Such variations or modifications are well within the spirit of this invention.

The numerical values given for various physical parameters, dimensions, and quantities are only approximate values and it is envisaged that the values higher than the numerical value assigned to the physical parameters, dimensions and quantities fall within the scope of the invention unless there is a statement in the specification to the contrary.

While considerable emphasis has been placed herein on the specific features of the preferred embodiment, it will be appreciated that many additional features can be added and that many changes can be made in the preferred embodiment without departing from the principles of the disclosure. These and other changes in the preferred embodiment of the disclosure will be apparent to those skilled in the art from the disclosure herein, whereby it is to be distinctly understood that the foregoing descriptive matter is to be interpreted merely as illustrative of the disclosure and not as a limitation.

1. A polymeric blend composite comprising;
a. 60 wt % to 99 wt % poly(ether ketone ketone);
b. 1 wt % to 6 wt % multi walled carbon nanotubes; and
c. 0 wt % to 40 wt % poly(2,5-benzimidazole),
wherein the weight percentages are based on the total weight of the polymeric blend composite;
wherein said poly(ether ketone ketone) has an inherent viscosity in the range of 0.60 to 1.8 dL/g;
wherein said poly(2,5-benzimidazole) has an inherent viscosity in the range of 0.90 to 4.00 dL/g; and
wherein said polymeric blend composite has:
electrical conductivity in the range of 10⁻¹¹ to 10⁻⁴ S/cm; and
storage modulus at 50° C. in the range of 2200 to 3400 MPa and at 300° C. in the range of 250 to 500 MPa.

2. The polymeric blend composite as claimed in claim 1, wherein the weight ratio of said poly (ether ketone ketone) to said poly (2, 5-benzimidazole) is in the range of 60:40 to 100:0.

3. The polymeric blend composite as claimed in claim 1, wherein the weight ratio of said poly (ether ketone ketone) to said poly (2, 5-benzimidazole) is 80:20.

4. The polymeric blend composite as claimed in claim 1, wherein the weight average molecular weight (M_{w}) of said poly(ether ketone ketone) is in the range of 50,000 to 60,000.

5. The polymeric blend composite as claimed in claim 1, wherein the bulk density of said poly (2,5-benzimidazole) is in the range of 1.00 to 3.00 dL/g.

6. The polymeric blend composite as claimed in claim 1, wherein said multi walled carbon nanotubes have an I_{D}/I_{G} value in the range of 0.9 to 1.2.

7. The polymeric blend composite as claimed in claim 1, wherein said composite has heat deflection temperature (HDT) in the range of 175° C. to 191° C.

8. A process for preparing said polymeric blend composite as claimed in claim 1, said process comprising the following steps:
a) pre-treating multi walled carbon nanotubes to obtain pre-treated multi walled carbon nanotubes;
b) mixing 60 wt % to 99 wt % of a poly(ether ketone ketone), 1 wt % to 6 wt % of said pre-treated multi walled carbon nanotubes and 0 wt % to 40 wt % of poly (2,5-benzimidazole) to obtain a powder dry blend;
c) extruding said powder dry blend at a temperature in the range of 300° C. to 450° C. to obtain said polymeric blend composite in the form of extrudates; and
d) pelletizing said extrudates to obtain said polymeric blend composite in the form of granules, by using a molding technique selected from the group consisting of injection molding, extrusion molding and compression molding.

9. The process as claimed in claim 8, wherein said pre-treatment of said multi walled carbon nanotubes comprises the following steps:
i. ultrasonicating a mixture of said multi walled carbon nanotubes and water at a frequency in the range of 15 to 25 kilohertz for a time period in the range of 10 minutes to 60 minutes to obtain uniformly dispersed multi walled carbon nanotubes; and
ii. drying said uniformly dispersed multi walled carbon nanotubes, under reduced pressure in the range of 760 mmHg to 60 mmHg, at a temperature in the range of 80° C. to 120° C., for a time period in the range of 1 hour to 48 hours to obtain said pre-treated multi walled carbon nanotubes.

10. The process as claimed in claim 8, wherein the weight ratio of said poly (ether ketone ketone) to said poly (2, 5-benzimidazole) is 80:20.
